(19) United States
(12) Patent Application Publication
(10) Pub. No.: US 2015/0015977 A1
(43) Pub. Date: Jan. 15, 2015

(54) FILTER FRAME FOR DIGITAL CAMERA MADE FROM POLYMER ELASTIC BODY

(71) Applicant: Yutaka Karasawa, Kamiina-gun (JP)

(72) Inventor: Yutaka Karasawa, Kamiina-gun (JP)

(21) Appl. No.: 14/371,112

(22) PCT Filed: Mar. 19, 2012
(86) PCT No.: PCT/JP2012/057676

§ 371 Date: Jul. 8, 2014

(30) Foreign Application Priority Data
Jan. 31, 2012 (JP) 2012-017789
Feb. 29, 2012 (JP) 2012-043297

(51) Int. Cl. G03B 11/04

(52) U.S. Cl. CPC G03B 11/04
USPC 359/892

(57) ABSTRACT

A digital camera filter frame reduces the load imposed on an autofocus motor provided in the main body of a camera due to a reduced weight, and prevents a situation in which the optical axis of a lens barrel of a digital camera varies when the digital camera filter frame is fitted to the front side of the lens barrel, and collides with something hard during use. A ring-like filter frame main body is produced by molding a polymer elastic body, and a filter lens having a specific effect is fitted to the ring-like filter frame main body.

### TECHNICAL FIELD

The invention relates to a digital camera filter frame. In particular, the invention relates to a digital camera filter frame that is produced using a polymer elastic body (i.e., synthetic resin).

The digital camera filter frame is produced by molding a thermosetting resin, a thermoplastic resin, or a composite material that utilizes a synthetic resin (e.g., fiber-reinforced plastic). The digital camera filter frame is characterized in that the digital camera filter frame has a reduced weight as compared with a filter frame made of a metal, ensures excellent water-tightness between the filter frame and a filter lens fitting section, and serves as a buffer to prevent a variation in the optical axis of a camera lens even when the filter frame fitted to the end of the lens barrel of a camera collides with something hard during use, for example.

### BACKGROUND ART

A digital camera filter is fitted to the front side of the lens barrel of a digital camera, and transmits light to an image sensor included in the camera while controlling (e.g., absorbing, transmitting, or changing) the light corresponding to the objective. The digital camera filter mainly includes a filter lens that is formed by an optical glass system, and a filter frame that holds the filter lens.

Patent Document 1 (JP-A-2005-301173) discloses examples of the material and the shape of a known digital camera filter frame. Patent Document 1 discloses a filter outer frame material that is obtained by plating a metal material, followed by black alumite chemical polishing (satin finishing). Specifically, the metal material is an aluminum material.

Patent Document 1 discloses a digital camera filter frame structure with high utility value (e.g., lens protection filter, circular polarizing filter, light intensity reduction filter, cross screen filter (special effect filter), and soft focus filter), and discloses the shape and processing technology necessary for the filter frame.

Patent Document 1 discloses a male thread that is provided on the back side of the filter outer frame, and screwed to the lens barrel of a digital camera, an optical system attachment connection female thread that is provided on the front side of the filter frame, a knurled section for a rotation operation that is formed on the outer circumference of the filter frame, a lens-retaining spring and a filter lens-retaining inward protrusion section for retaining a filter lens, and the like.

A known digital camera filter frame such as that disclosed in Patent Document 1 is formed using aluminum or brass (i.e., metal material). Therefore, a known digital camera filter frame is normally heavy, and increases the load imposed on an autofocus motor.

Since a known digital camera filter frame has a structure in which a filter lens that is formed by an optical glass system is fitted to a metal frame (e.g., aluminum frame), and merely secured (fastened) using a lens-retaining edge or a ring-like retention spring, water-tightness between the filter frame and the filter lens fitting section is poor.

Since a known digital camera filter frame that is made of a metal (i.e., a filter having a filter frame made of a metal) is normally fitted to the front side of the lens barrel of a digital camera, an impact suffered by the filter frame when the filter frame collides with something hard is transmitted directly to the lens barrel of the digital camera through the filter frame, and the optical axis of the lens barrel of the camera lens varies. A solution to this problem has been desired.

### RELATED-ART DOCUMENT

### Patent Document

### Patent Document 1: JP-A-2005-301173

### SUMMARY OF THE INVENTION

### Technical Problem

An object of the invention is to reduce the load imposed on an autofocus motor provided in the main body of a digital camera by reducing the weight of various filters that are fitted to the front side of the lens barrel of the digital camera.

A known digital camera filter frame has a structure in which a filter lens that formed by an optical glass system is fitted to a metal frame (e.g., aluminum frame), and merely secured (fastened) using a lens-retaining edge or a ring-like retention spring, and has a problem in which water-tightness between the filter frame and the filter lens fitting section is poor. Another object of the invention is to solve this problem.

When a digital camera filter frame is made of a metal, an impact suffered by the filter frame fitted to the front side of the lens barrel of a digital camera when the filter frame collides with something hard is transmitted directly to the lens barrel of the digital camera, and the optical axis of the lens barrel of the camera lens varies. A further object of the invention is to solve this problem.

### Solution to Problem

Several aspects of the invention provide a filter frame that is produced by producing a ring-like filter frame main body by molding a polymer elastic body, and fitting a filter lens having a specific effect to the ring-like filter frame main body.

The digital camera filter frame may be produced by molding the polymer elastic body to produce a ring-like filter frame main body, forming a filter lens-retaining inward protrusion section (lens-retaining inward protrusion section) and a lens fitting section on the inner surface of the ring-like filter frame main body, fitting a filter lens to the lens-retaining inward protrusion section and the lens fitting section, and plastically deforming the end of the peripheral edge section of the lens fitting section by thermal caulking to secure the filter lens on the ring-like filter frame main body.

The ring-like filter frame main body may be produced by molding a thermosetting resin, a thermoplastic resin, or a composite material that utilizes a synthetic resin (e.g., fiber-reinforced plastic) as the polymer elastic body, and a polymer elastic body that exhibits relatively high elasticity may be selected as the polymer elastic body.

The parts that form the ring-like filter frame main body may be respectively produced by molding a material arbitrarily selected from a thermosetting resin, a thermoplastic resin, and a composite material that utilizes a synthetic resin (e.g., fiber-reinforced plastic), and secured (coupled) by thermal caulking, ultrasonic welding, and bonding using an adhesive to produce the filter frame.

The ring-like filter frame main body may be produced by molding a thermoplastic resin or a composite material that utilizes a synthetic resin (e.g., fiber-reinforced plastic) as the polymer elastic body, and a polymer elastic body that exhibits moderate elasticity may be selected as the polymer elastic body (i.e., more specific solution).

The ring-like filter frame main body that is produced by molding a thermoplastic resin or a composite material that utilizes a synthetic resin (e.g., fiber-reinforced plastic) as the polymer elastic body, may include a lens-retaining inward protrusion section and a lens fitting section for the filter lens that are formed on the inner surface of the ring-like filter frame main body, the filter lens that is fitted from the back side to the lens-retaining inward protrusion section so that the circumferential edge of the filter lens comes in contact with the lens-retaining inward protrusion section, and a lens-retaining ring that is fitted to the back side of the filter lens, and can be pressure-welded to the edge of the lens fitting section by ultrasonic welding, and the filter lens may be secured on the ring-like filter frame main body via the lens-retaining inward protrusion section and the lens-retaining ring.

The lens-retaining ring that can be welded to the edge of the lens fitting section by ultrasonic welding may include a lens-retaining ring that has a contact section that comes in contact with the circumferential edge of the filter lens, and a welding ring section that protrudes from the lens-retaining ring, and the end of the welding ring section may form a welding allowance (i.e., efficient configuration).

A contact section that forms a circumferential edge section may respectively be formed on the lens-retaining inward protrusion section of the filter frame main body and the contact section of the lens-retaining ring with the filter lens, an irregular streak-like protrusion that is formed along a circumferential direction may be provided to each contact section, and the irregular streak-like protrusions may hold the filter lens when the lens-retaining ring is pressure-welded to the lens-retaining inward protrusion section by ultrasonic welding to improve water-tightness between the lens-retaining ring and the filter lens, and between the filter lens and the lens-retaining inward protrusion section.

### Advantageous Effects of the Invention

Several aspects of the invention thus provide a ring-like filter frame which is produced by molding a polymer elastic body and to which a filter lens having a specific effect is fitted. Specifically, several aspects of the invention thus provide a digital camera filter frame that is formed of a polymer elastic body, and produced by molding the polymer elastic body to produce a ring-like filter frame, forming a lens-retaining inward protrusion section and a lens fitting section on the inner surface of the ring-like filter frame, fitting a filter lens to the lens-retaining inward protrusion section and the lens fitting section, and plastically deforming the end of the peripheral edge section of the lens fitting section by thermal caulking to secure the filter lens on the ring-like filter frame. The filter frame according to the second embodiment of the invention can reduce the weight of a filter that is fitted to the front side of the lens barrel of a digital camera as compared with a known filter frame produced using a metal material (e.g., aluminum), and can significantly reduce the load imposed on an autofocus motor provided in the main body of the digital camera.

Since the ring-like filter frame main body is produced by molding the polymer elastic body that exhibits relatively high elasticity (e.g., a thermosetting resin, a thermoplastic resin, or a composite material that utilizes a synthetic resin (e.g., fiber-reinforced plastic)), an impact suffered by the ring-like filter frame fitted to the front side of the lens barrel of the digital camera when the filter frame collides with something hard can be buffered by the elasticity of the filter frame (i.e., is not transmitted to the lens barrel), and a situation in which the optical axis of the lens barrel varies can be prevented.

One aspect of the invention can provide a digital camera filter frame wherein a contact section that forms a circumferential edge section is respectively formed on the lens-retaining inward protrusion section formed on the filter frame main body and the contact section of the lens-retaining ring with the filter lens, the irregular streak-like protrusion that is formed along the circumferential direction is provided to each contact section, and the irregular streak-like protrusions hold the filter lens when the lens-retaining ring is pressure-welded to the lens-retaining inward protrusion section by ultrasonic welding to improve water-tightness between the lens-retaining ring and the filter lens, and between the filter lens and the lens-retaining inward protrusion section.

Since the filter frame according to several aspects of the invention is produced by molding the polymer elastic body (e.g., a thermosetting resin, a thermoplastic resin, or a composite material that utilizes a synthetic resin (e.g., fiber-reinforced plastic)), the filter frame can be mass-produced, and the production cost can be significantly reduced.

### BRIEF DESCRIPTION OF DRAWINGS

FIG. 1 is a view illustrating a state when a filter frame according to the invention is fitted.

FIG. 2 is a cross-sectional view illustrating the main part of a filter frame according to the first and second embodiments of the invention.

FIG. 3A is an enlarged view (assembly explanatory diagram) illustrating the section enclosed by the line A-A in FIG. 2, and FIG. 3B is an enlarged view illustrating the section enclosed by the line A-A in FIG. 2 after completion of assembly (first embodiment).

FIG. 4 is an assembly diagram illustrating the second embodiment of the invention.

FIG. 5 is a cross-sectional view illustrating the main part of a filter frame according to the third to fifth embodiments of the invention.

FIG. 6A is an enlarged view (assembly explanatory diagram) illustrating the section enclosed by the line B-B in FIG. 5, and FIG. 6B is an enlarged view illustrating the section enclosed by the line B-B in FIG. 5 after completion of assembly (third embodiment).

FIG. 7A is an enlarged view (assembly explanatory diagram) illustrating the section enclosed by the line B-B in FIG. 5, and FIG. 7B is an enlarged view illustrating the section enclosed by the line B-B in FIG. 5 after completion of assembly (fourth embodiment).

FIG. 8A is an enlarged view (assembly explanatory diagram) illustrating the section enclosed by the line B-B in FIG. 5, and FIG. 8B is an enlarged view illustrating the section enclosed by the line B-B in FIG. 5 after completion of assembly (fifth embodiment).

FIG. 9A is an enlarged view illustrating a lens-retaining inward protrusion, and FIG. 9B is an enlarged view illustrating a lens-retaining ring (fifth embodiment).

### DESCRIPTION OF EMBODIMENTS

The invention relates to a digital camera filter frame. In particular, the invention relates to a digital camera filter frame that is produced using a polymer elastic body (i.e., synthetic resin).

The term “polymer elastic body” used herein refers to a thermosetting resin, a thermoplastic resin, a composite material that utilizes a synthetic resin (e.g., fiber-reinforced plastic), and the like.

The term “thermosetting resin” used herein refers to a resin that polymerizes (i.e., cures) when heated to form a polymer network structure, and does not return to the original state. Examples of the thermosetting resin include a phenol resin (PF), an epoxy resin (EP), a melamine resin (MF), a urea resin (UF), an unsaturated polyester resin (UP), a polyurethane (PUR), a thermosetting polyimide (PI), and the like.

The term “thermoplastic resin” used herein refers to a resin that softens when heated to the glass transition temperature or the melting point, and can be molded into the desired shape. Since it is normally difficult to machine (e.g., cut or grind) the thermoplastic resin, injection molding (that pours the thermoplastic resin that has softened by heating into a die, and cools the thermoplastic resin to effect solidification) and the like have been widely used. The thermoplastic resin is classified into a commodity plastic, an engineering plastic, a super-engineering plastic, and the like depending on the application.

Examples of the commodity plastic that may be used in connection with the invention include polyethylene (PE), polypropylene (PP), polyvinyl chloride (PVC), polystyrene (PS), polytetrafluoroethylene (PTFE), an ABS resin, an acrylic resin, and the like.

Examples of the engineering plastic that may be used in connection with the invention include a polyamide (PA), polyacetal (POM), a polycarbonate (PC), polybutylene terephthalate (PBT), polyethylene terephthalate (PET), glass fiber-reinforced polyethylene terephthalate (GF-PET), and the like.

Examples of the super-engineering plastic that may be used in connection with the invention include polyphenylene sulfide (PPS), polytetrafluoroethylene (PTFE), polysulfone (PSF), polyethersulfone (PES), polyarylate (PAR), a liquid crystal polymer (LCP), a thermoplastic polyimide (PI), polyamideimide (PAI), and the like.

Examples of the composite material that utilizes a synthetic resin (e.g., fiber-reinforced plastic) that may be used in connection with the invention include a glass fiber-reinforced plastic (GFRP), a carbon fiber-reinforced plastic (CFRP), and the like.

The invention reduces the load imposed on an autofocus motor provided in the main body of a digital camera by reducing the weight of a filter that is fitted to the front side of the lens barrel of the digital camera.

When the digital camera filter frame is made of a metal, an impact suffered by the filter frame fitted to the front side of the lens barrel of the digital camera when the filter frame collides with something hard is transmitted directly to the lens barrel of the digital camera, and the optical axis of the lens barrel of the camera lens varies. The invention also solves this problem.

The invention also provides a digital camera filter frame wherein a contact section that forms a circumferential edge section is respectively formed on a lens-retaining inward protrusion section formed on the filter frame main body and the contact section of a lens-retaining ring with the filter lens, an irregular streak-like protrusion that is formed along the circumferential direction is provided to each contact section, and the irregular streak-like protrusions hold the filter lens when the lens-retaining ring is pressure-welded to the lens-retaining inward protrusion section by ultrasonic welding to improve water-tightness between the lens-retaining ring and the filter lens, and between the filter lens and the lens-retaining inward protrusion section.

Since the filter frame is produced by molding the polymer elastic body (e.g., a thermosetting resin, a thermoplastic resin, or a composite material that utilizes a synthetic resin (e.g., fiber-reinforced plastic)), the filter frame can be mass-produced, and the production cost can be significantly reduced.

It is preferable that the filter frame that is fitted to the front side of the lens barrel of a digital camera to control light be produced as a ring-like filter frame main body by molding the polymer elastic body, and a filter lens having a specific effect be fitted to the ring-like filter frame main body.

It is preferable that the filter frame be a digital camera filter frame formed of the polymer elastic body that is produced by molding the polymer elastic body to produce a ring-like filter frame main body, forming a filter lens-retaining inward protrusion section (lens-retaining inward protrusion section) and a lens fitting section to form the inner surface of the ring-like filter frame main body, fitting a filter lens to the lens-retaining inward protrusion section and the lens fitting section, and plastically deforming the end of the peripheral edge section of the lens fitting section by thermal caulking to secure the filter lens on the ring-like filter frame main body.

It is preferable that the ring-like filter frame main body (i.e., a digital camera filter frame formed of a polymer elastic body) be produced by molding a thermosetting resin, a thermoplastic resin, or a composite material that utilizes a synthetic resin (e.g., fiber-reinforced plastic) as the polymer elastic body, a polymer elastic body that exhibits relatively high elasticity being selected as the polymer elastic body.

It is preferable that the parts that form the ring-like filter frame main body (i.e., a digital camera filter frame formed of a polymer elastic body) be respectively produced by molding a material arbitrarily selected from a thermosetting resin, a thermoplastic resin, and a composite material that utilizes a synthetic resin (e.g., fiber-reinforced plastic), and secured (coupled) by thermal caulking, ultrasonic welding, and bonding using an adhesive to produce the filter frame.

It is particularly preferable that the ring-like filter frame main body (i.e., a digital camera filter frame formed of a polymer elastic body) be produced by molding a thermoplastic resin or a composite material that utilizes a synthetic resin (e.g., fiber-reinforced plastic) as the polymer elastic body, a polymer elastic body that exhibits moderate elasticity being selected as the polymer elastic body.

It is preferable that the digital camera filter frame formed of a polymer elastic body include a lens-retaining inward protrusion section and a lens fitting section for the filter lens that are formed on the inner surface of the ring-like filter frame main body, the filter lens that is fitted from the back side to the lens-retaining inward protrusion section so that the circumferential edge of the filter lens comes in contact with the lens-retaining inward protrusion section, and a lens-retaining ring that is fitted to the back side of the filter lens, and can be pressure-welded to the edge of the lens fitting section by ultrasonic welding, wherein the filter lens is secured on the ring-like filter frame main body via the lens-retaining inward protrusion section and the lens-retaining ring.

It is also preferable that the digital camera filter frame formed of a polymer elastic body include a lens-retaining inward protrusion section and a lens fitting section for the filter lens that are formed on the inner surface of the ring-like filter frame main body, the filter lens that is fitted from the front side to the lens-retaining inward protrusion section so that a circumferential edge of the filter lens comes in contact with the lens-retaining inward protrusion section, and a lens-retaining ring that is fitted to the front side of the filter lens, and can be pressure-welded to the edge of the lens fitting section by ultrasonic welding, wherein the filter lens is secured on the ring-like filter frame main body via the lens-retaining inward protrusion section and the lens-retaining ring.

It is preferable that the lens-retaining ring that can be welded to the edge of the lens fitting section by ultrasonic welding include a lens-retaining ring that has a contact section that comes in contact with the circumferential edge of the filter lens, and a welding ring section that protrudes from the lens-retaining ring, and the end of the welding ring section form a welding allowance.

It is preferable that a contact section that forms a circumferential edge section is respectively formed on the lens-retaining inward protrusion section of the filter frame main body and the contact section of the lens-retaining ring with the filter lens, an irregular streak-like protrusion that is formed along a circumferential direction be provided to each contact section, and the irregular streak-like protrusions hold the filter lens when the lens-retaining ring is pressure-welded to the lens-retaining inward protrusion section by ultrasonic welding to improve water-tightness between the lens-retaining ring and the filter lens, and between the filter lens and the lens-retaining inward protrusion section.

### First Embodiment

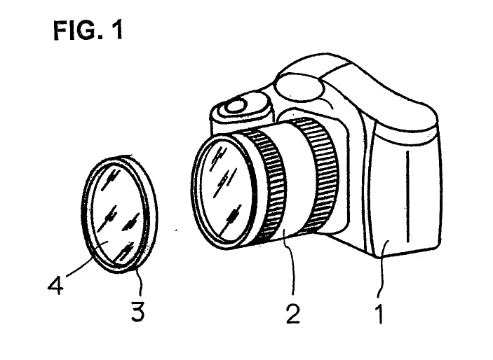

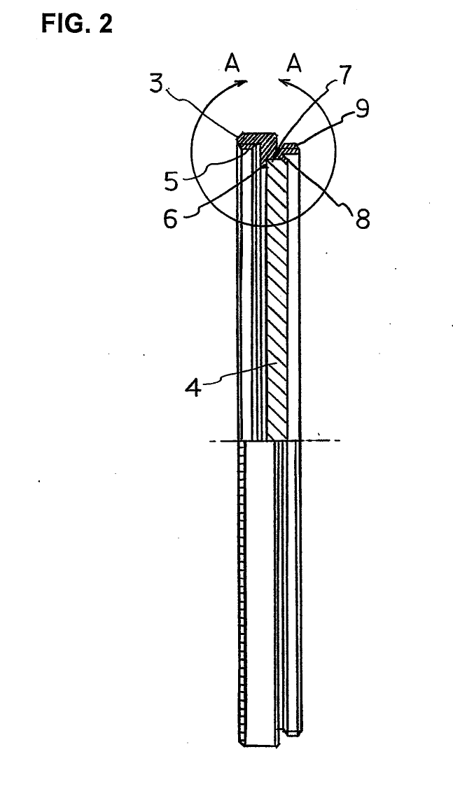

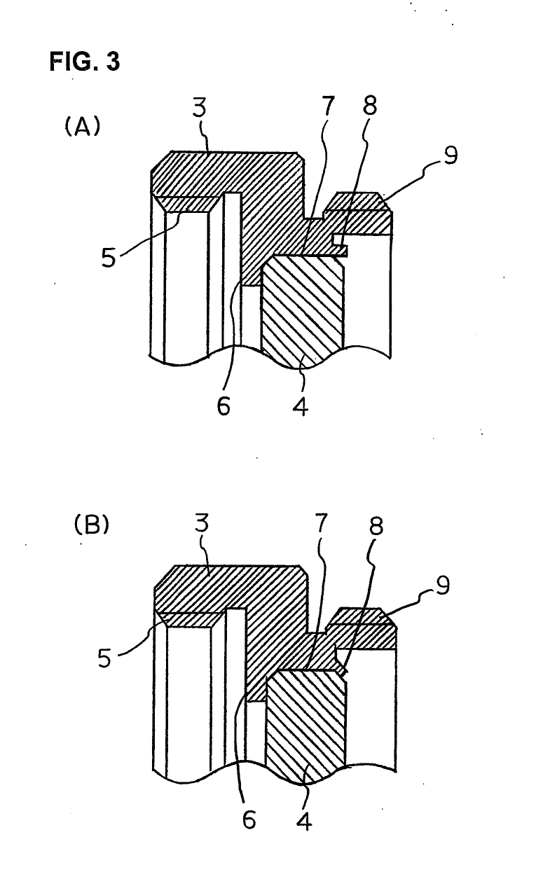

FIGS. 1 to 3B illustrate a first embodiment of the invention. FIG. 1 is a view illustrating a state when a filter frame according to the first embodiment of the invention is fitted, FIG. 2 is a cross-sectional view illustrating the main part of the filter frame according to the first embodiment of the invention, and FIGS. 3A and 3B are enlarged views (assembly explanatory diagrams) illustrating the section enclosed by the line A-A in FIG. 2.

In FIG. 1, reference sign 1 indicates the main body of a digital single-lens reflex camera, reference sign 2 indicates a lens barrel, and reference sign 3 indicates a digital camera filter frame main body formed of a polymer elastic body. A digital camera filter mainly includes a filter lens 4 that is formed by an optical glass system, and the filter frame main body 3 that has a ring-like shape and holds the filter lens 4. The filter frame main body 3 is fitted to the front side of the lens barrel 2 of the digital camera, and transmits light to an image sensor included in the camera while controlling light (e.g., absorbing, transmitting, or changing light) via the filter lens 4 corresponding to the objective.

FIG. 2 is a cross-sectional view illustrating the main part of the filter frame main body 3. The filter frame main body 3 includes a female thread 5 to which another optical system attachment is screwed (fitted), a lens-retaining inward protrusion section 6, a lens fitting section 7 to which the filter lens 4 is fitted, a peripheral edge section 8 of the lens fitting section 7, and a male thread 9 that is screwed and fitted to the lens barrel 2 (sequentially from the front side). The female thread 5, the lens-retaining inward protrusion section 6, the lens fitting section 7, the peripheral edge section 8, and the male thread 9 are obtained by molding the polymer elastic body to form the ring-like filter frame main body 3.

FIGS. 3A and 3B are enlarged views (assembly explanatory diagrams) illustrating the section enclosed by the line A-A in FIG. 2. As illustrated in FIGS. 3A and 3B, the polymer elastic body is molded to obtain the ring-like filter frame main body 3. The lens-retaining inward protrusion section 6 and the lens fitting section 7 are formed on the inner surface of the ring-like filter frame main body 3. After fitting the filter lens 4 to the lens-retaining inward protrusion section 6 and the lens fitting section 7 (see FIG. 3A), the peripheral edge section 8 of the lens fitting section 7 is plastically deformed by thermal caulking to secure the filter lens 4 on the ring-like filter frame main body 3 (see FIG. 3B). In the first embodiment, the female thread 5 can be molded using a forcible removal die on which a stopper protrudes, and the male thread 9 can be molded using a split die.

The ring-like filter frame main body 3 according to the first embodiment is thus produced by molding the polymer elastic body. Since the ring-like filter frame main body 3 is produced by molding the polymer elastic body that is a thermosetting resin, a thermoplastic resin, or a composite material that utilizes a synthetic resin (e.g., fiber-reinforced plastic), the filter frame main body 3 functions as a buffer by arbitrarily selecting a polymer elastic body that exhibits relatively high elasticity. Moreover, it is possible to produce the filter frame main body 3 having a significantly reduced weight as compared with a filter frame made of a metal.

### Second Embodiment

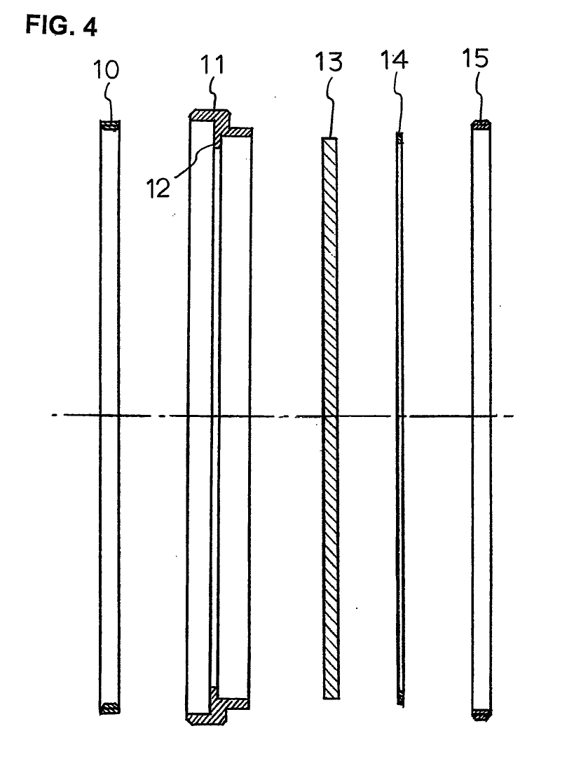

FIG. 4 is an assembly diagram illustrating a second embodiment of the invention. In FIG. 4, reference sign 10 indicates a female thread part, reference sign 11 indicates a filter outer frame that has a filter lens-retaining inward protrusion section 12 on the inner side thereof, reference sign 13 indicates a filter lens, reference sign 14 indicates a filter lens-retaining ring, and reference sign 15 indicates a male thread part. The female thread part 10, the filter outer frame 11, the filter lens-retaining ring 14, and the male thread part 15 are respectively produced using a material arbitrarily selected from a thermosetting resin, a thermoplastic resin, and a composite material that utilizes a synthetic resin (e.g., fiber-reinforced plastic). The female thread part 10, the filter outer circumferential frame 11, the filter lens-retaining ring 14, and the male thread part 15 are secured and coupled by thermal caulking, ultrasonic welding, and bonding using an adhesive to produce a digital camera filter frame formed of a polymer elastic body.

The second embodiment of the invention thus provides a ring-like filter frame which is produced by molding a polymer elastic body and to which a filter lens having a specific effect is fitted. Specifically, the second embodiment of the invention provides a digital camera filter frame that is formed of a polymer elastic body, and produced by molding the polymer elastic body to produce a ring-like filter frame, forming a lens-retaining inward protrusion section and a lens fitting section on the inner surface of the ring-like filter frame, fitting a filter lens to the lens-retaining inward protrusion section and the lens fitting section, and plastically deforming the end of the peripheral edge section of the lens fitting section by thermal caulking to secure the filter lens on the ring-like filter frame. The filter frame according to the second embodiment of the invention can reduce the weight of a filter that is fitted to the front side of the lens barrel of a digital camera as compared with a known filter frame produced using a metal material (e.g., aluminum), and can significantly reduce the load imposed on an autofocus motor provided in the main body of the digital camera.

Since the ring-like filter frame according to the second embodiment of the invention is produced by molding the polymer elastic body that exhibits relatively high elasticity (e.g., a thermosetting resin, a thermoplastic resin, or a composite material that utilizes a synthetic resin (e.g., fiber-reinforced plastic)), an impact suffered by the ring-like filter frame fitted to the front side of the lens barrel of the digital camera when the filter frame collides with something hard during use can be buffered by the elasticity of the filter frame (i.e., is not transmitted to the lens barrel), and a situation in which the optical axis of the lens barrel varies can be prevented.

Since the filter frame according to the second embodiment of the invention is produced by molding the polymer elastic body (e.g., a thermosetting resin, a thermoplastic resin, or a composite material that utilizes a synthetic resin (e.g., fiber-reinforced plastic)), the filter frame can be mass-produced, and the production cost can be significantly reduced.

### Third Embodiment

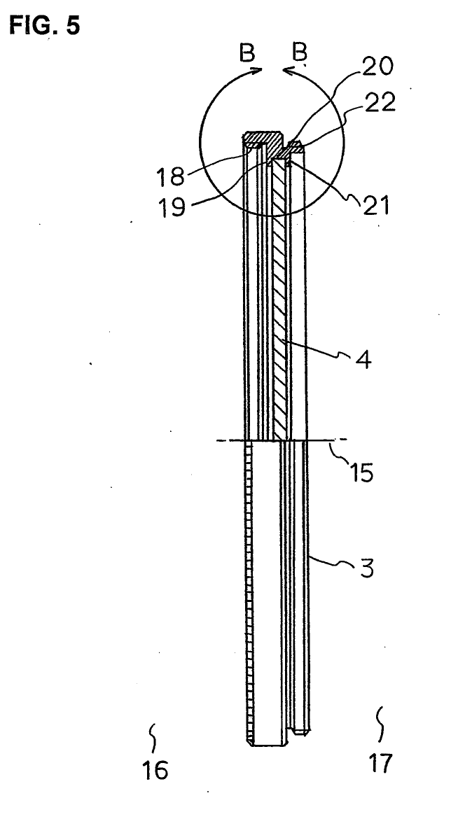

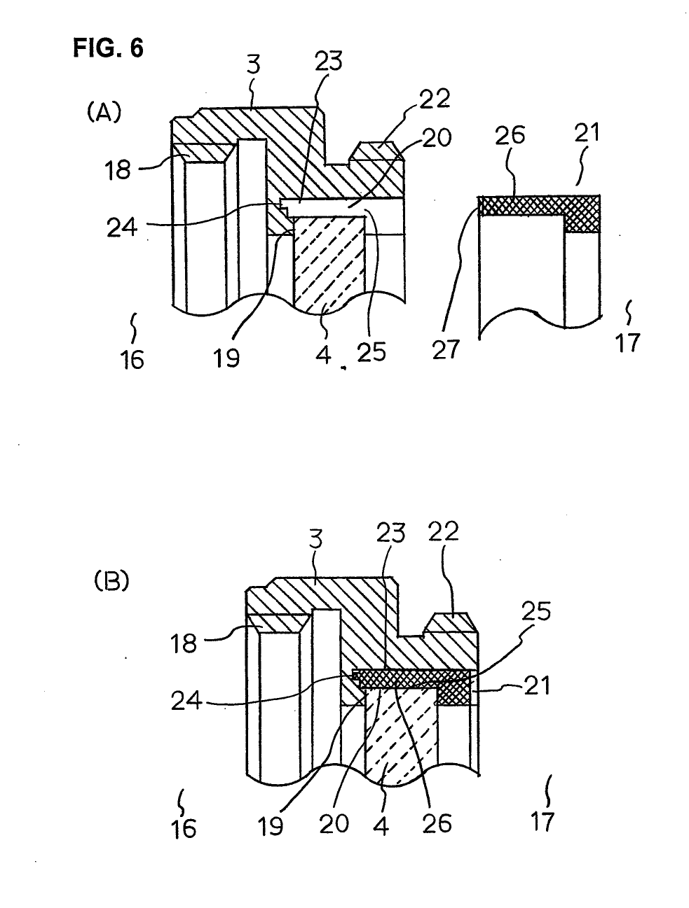

FIGS. 1, 5, 6A, and 6B illustrate a third embodiment of the invention. FIG. 1 is a view illustrating a state when a filter frame according to the third embodiment of the invention is fitted, FIG. 5 is a cross-sectional view illustrating the main part of the filter frame according to the third embodiment of the invention, and FIGS. 6A and 6B are enlarged views (assembly explanatory diagrams) illustrating the section enclosed by the line B-B in FIG. 5.

In FIG. 1, reference sign 1 indicates the main body of a digital camera, reference sign 2 indicates a lens barrel, and reference sign 3 indicates a digital camera filter frame main body formed of a thermoplastic resin or a composite material (e.g., fiber-reinforced plastic). A digital camera filter mainly includes a filter lens 4 that is formed by an optical glass system, and the filter frame main body 3 that has a ring-like shape and holds the filter lens 4. The filter frame main body 3 is fitted to the front side of the lens barrel 2 of the digital camera, and transmits light to an image sensor included in the camera while controlling light (e.g., absorbing, transmitting, or changing light) via the filter lens 4 corresponding to the objective.

FIG. 5 is a cross-sectional view illustrating the main part of the filter frame main body 3. In FIG. 5, reference sign 3 indicates the filter frame main body, reference sign 4 indicates the filter lens, reference sign 15 indicates the optical axis of the filter lens, reference sign 16 indicates the front side of the filter lens (i.e., the light-incident side), and reference sign 17 indicates the back side of the filter lens (i.e., the side fitted to the lens barrel). The filter frame main body 3 includes a female thread 18 to which another optical system attachment is screwed (fitted), a lens-retaining inward protrusion section 19, a lens fitting section 20 to which the filter lens 4 is fitted, a lens-retaining ring 21, and a male thread 22 that is screwed and fitted to the lens barrel 2 (sequentially from the front side 16 in FIG. 5). The female thread 18, the lens-retaining inward protrusion section 19, the lens fitting section 20, the lens-retaining ring 21, and the male thread 22 are produced by molding a thermoplastic resin or a composite material that utilizes a synthetic resin (e.g., fiber-reinforced plastic) having moderate elasticity to produce the ring-like filter frame main body 3. The filter lens 4 having a specific effect is fitted to the ring-like filter frame main body 3.

FIG. 6A is an enlarged view (assembly explanatory diagram) illustrating the section enclosed by the line B-B in FIG. 5, and FIG. 6B is an enlarged view illustrating the section enclosed by the line B-B in FIG. 5 after completion of assembly. As illustrated in FIG. 6A, a thermoplastic resin or a composite material that utilizes a synthetic resin (e.g., fiber-reinforced plastic) having moderate elasticity is molded to obtain the ring-like filter frame main body 3. The lens-holding inward protrusion section 19 and the lens fitting section 20 are formed on the inner surface of the ring-like filter frame main body 3. After fitting the filter lens 4 to the lens-holding inward protrusion section 19 and the lens fitting section 20 (see FIG. 6A), a burr groove 24 and a welding ring fitting groove 25 are formed in a peripheral edge section 23 of the lens fitting section 20.

Reference sign 21 indicates a lens-retaining ring. A welding ring section 26 in the shape of a protrusion is formed on the lens-retaining ring 21. A welding allowance 27 is provided to the edge of the welding ring section 26.

In the third embodiment, the female thread 18 can be molded using a forcible removal die on which a stopper protrudes, and the male thread 22 can be molded using a split die.

FIG. 6B illustrates a state in which the lens-retaining ring 21 has been fitted to the lens fitting section 20, and the lens-retaining ring 21 has been ultrasonic-welded to the filter frame main body 3 using an ultrasonic welder. In FIG. 6B, the filter lens 4 comes in pressure contact with the lens-retaining inward protrusion section 19 that forms the inner surface of the filter frame main body 3 due to the lens-retaining ring 21 (i.e., the filter lens 4 is held between the lens-retaining inward protrusion section 19 and the lens-retaining ring 21). Since the welding allowance 27 of the welding ring section 26 of the lens-retaining ring 21 has been melted during welding, and part of the welding allowance 27 is situated in the burr groove 24, the filter lens 4 is firmly held between the lens-retaining inward protrusion section 19 and the lens-retaining ring 21. In the example illustrated in FIG. 6B, since the edge of the filter lens 4 serves as a stopper during pressure welding, and the lens-retaining ring 21 is pressure-welded to the lens-retaining inward protrusion section 19 by ultrasonic welding, excellent water-tightness can be achieved between the lens-retaining ring 21 and the filter lens 4, and between the filter lens 4 and the lens-retaining inward protrusion section 19.

The third embodiment of the invention thus provides the ring-like digital camera filter frame main body 3 that is fitted to the front side of the lens barrel 2 of the digital camera to control light, and is produced by molding a thermoplastic resin or a composite resin (e.g., fiber-reinforced plastic) having moderate elasticity, the filter lens 4 having a specific effect being fitted to the ring-like filter frame main body 3.

The third embodiment of the invention provides a digital camera filter frame that includes the ring-like filter frame main body 3 that is fitted to the front side of the lens barrel 2 of the digital camera to control light, and is produced by molding a thermoplastic resin or a composite resin (e.g., fiber-reinforced plastic) having moderate elasticity, the filter lens 4 that is fitted (from the back side 17) to the lens-retaining inward protrusion section 19 and the lens fitting section 20 formed on the inner surface of the ring-like filter frame main body 3 so that the circumferential edge of the filter lens 4 comes in contact with the lens-retaining inward protrusion section 19, and the lens-retaining ring 21 that is fitted to the back side 17 of the filter lens 4, and can be pressure-welded to the edge of the lens fitting section 20 by ultrasonic welding, wherein the filter lens 4 is secured on the ring-like filter frame main body 3 via the lens-retaining inward protrusion section 19 and the lens-retaining ring 21.

### Fourth Embodiment

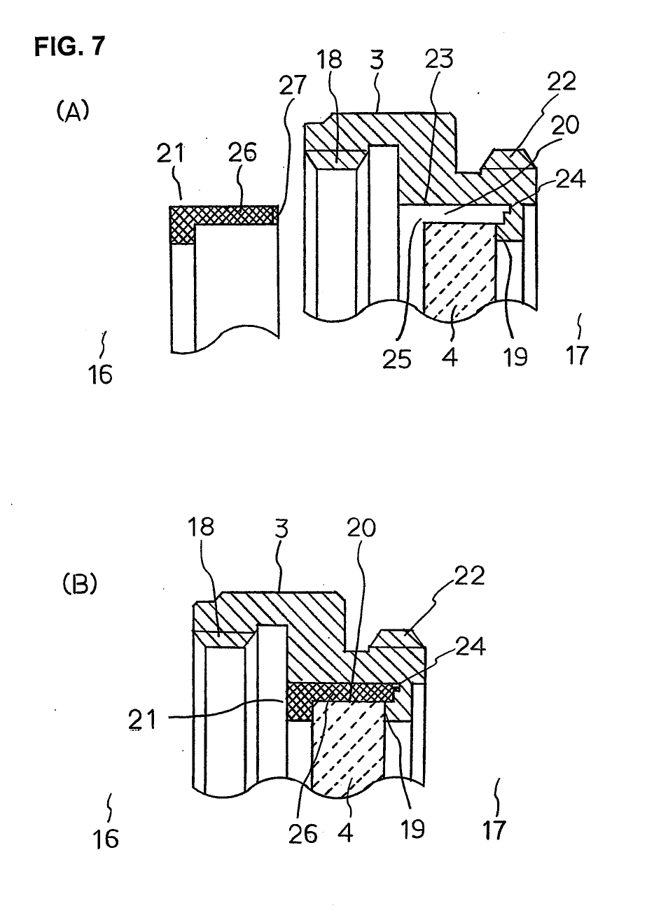

FIGS. 7A and 7B illustrate a fourth embodiment of the invention. FIG. 7A is an enlarged view (assembly explanatory diagram) illustrating the section enclosed by the line B-B in FIG. 5, and FIG. 7B is an enlarged view illustrating the section enclosed by the line B-B in FIG. 5 after completion of assembly. In FIGS. 7A and 7B, reference sign 3 indicates a ring-like filter frame main body, reference sign 4 indicates a filter lens, reference sign 16 indicates the front side of the filter lens (i.e., the light-incident side), and reference sign 17 indicates the back side of the filter lens (i.e., the side that is fitted to the lens barrel). Reference sign 18 indicates a female thread, reference sign 19 indicates a lens-retaining inward protrusion section, reference sign 20 indicates a lens fitting section, reference sign 21 indicates a lens-retaining ring, reference sign 22 indicates a male thread, reference sign 23 indicates a circumferential edge, reference sign 24 indicates a burr groove, reference sign 25 indicates a welding ring fitting groove, reference sign 26 indicates a welding ring, and reference sign 27 indicates a welding allowance.

In the fourth embodiment, the female thread 18 can be molded using a forcible removal die on which a stopper protrudes, and the male thread 22 can be molded using a split die.

In the fourth embodiment, the lens-retaining inward protrusion section 19 is provided on the back side 17 of the filter frame main body 3, the filter lens 4 that comes in contact with the lens-retaining inward protrusion section 19 is fitted from the front side 16 (i.e., the light-incident side), the lens-retaining ring 21 is fitted from the front side 16 (i.e., the light-incident side), and the filter lens 4 is secured on the inner surface of the filter frame main body 3 by ultrasonic welding (see FIG. 7A).

The fourth embodiment of the invention thus provides a digital camera filter frame that includes the ring-like filter frame main body 3 that is fitted to the front side of the lens barrel 2 (see FIG. 1) of the digital camera to control light, and is produced by molding a thermoplastic resin or a composite resin (e.g., fiber-reinforced plastic) having moderate elasticity, the filter lens 4 that is fitted (from the front side 16) to the lens-retaining inward protrusion section 19 and the lens fitting section 20 formed on the inner surface of the ring-like filter frame main body 3 so that the circumferential edge 23 of the filter lens 4 comes in contact with the lens-retaining inward protrusion section 19, and the lens-retaining ring 21 that is fitted to the front side 16 of the filter lens 4, and can be pressure-welded to the edge of the lens fitting section 20 by ultrasonic welding, wherein the filter lens 4 is secured on the ring-like filter frame main body 3 via the lens-retaining inward protrusion section 19 and the lens-retaining ring 21 (see FIG. 7B).

### Fifth Embodiment

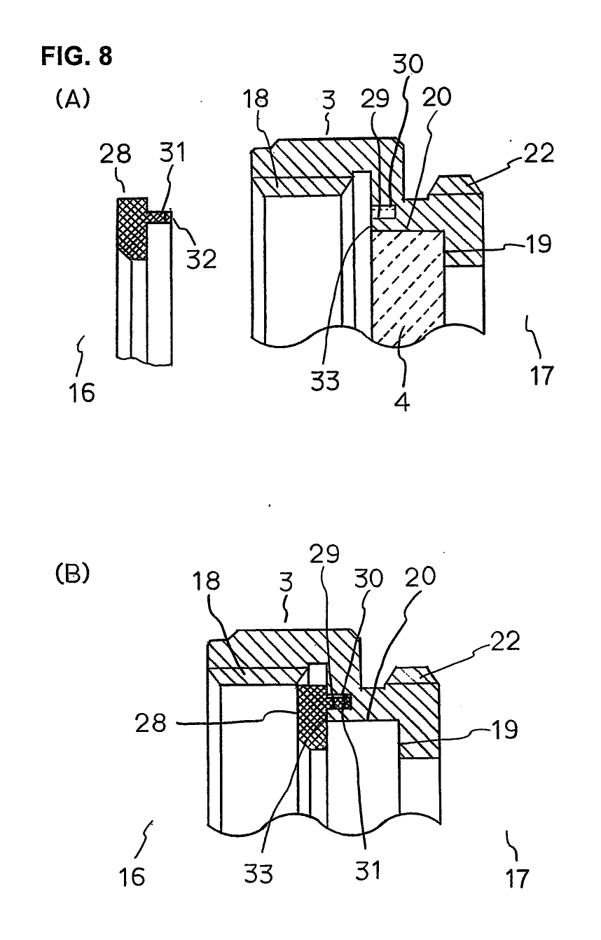

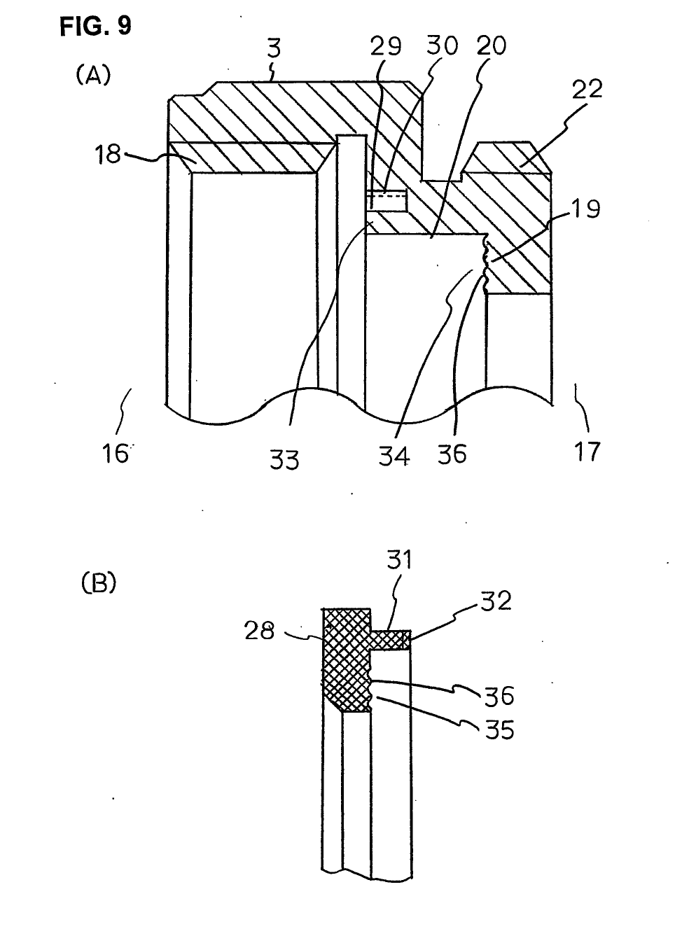

FIGS. 8A to 9B illustrate a fifth embodiment of the invention. FIG. 8A is an enlarged view (assembly explanatory diagram) illustrating the section enclosed by the line B-B in FIG. 5, FIG. 8B is an enlarged view illustrating the section enclosed by the line B-B in FIG. 5 after completion of assembly, FIG. 9A is an enlarged view illustrating a lens-retaining inward protrusion section according to the fifth embodiment of the invention, and FIG. 9B is an enlarged view illustrating a lens-retaining ring according to the fifth embodiment of the invention. In FIGS. 8A and 8B, reference sign 3 indicates a ring-like filter frame main body, reference sign 4 indicates a filter lens, reference sign 16 indicates the front side of the filter lens (i.e., the light-incident side), and reference sign 17 indicates the back side of the filter lens (i.e., the side that is fitted to the lens barrel). Reference sign 18 indicates a female thread, reference sign 19 indicates a lens-retaining inward protrusion section, reference sign 20 indicates a lens fitting section, reference sign 28 indicates a lens-retaining ring, reference sign 22 indicates a male thread, reference sign 29 indicates a welding ring fitting groove that is formed so as not to come in contact with the circumferential edge of the filter lens 4, reference sign 30 indicates a burr groove that is provided in the outer circumference of the welding ring fitting groove, reference sign 31 indicates a welding ring that is integrated with the lens-retaining ring 28, reference sign 32 indicates a welding allowance that is provided at the end of the welding ring, and reference sign 33 indicates a welding stopper.

In the fifth embodiment, the lens-retaining inward protrusion section 19 is provided on the back side 17 of the filter frame main body 3, the filter lens 4 that comes in contact with the lens-retaining inward protrusion section 19 is fitted from the front side 16 (i.e., the light-incident side), the lens-retaining ring 28 is fitted from the front side 16 (i.e., the light-incident side), and the filter lens 4 is secured on the inner surface of the filter frame main body 3 by ultrasonic welding (see FIG. 8A). The welding ring fitting groove 29 to which the lens-retaining ring 28 that is heated is fitted does not come in contact with the circumferential edge of the filter lens 4 (i.e., is formed as an independent groove).

The fifth embodiment of the invention thus provides a digital camera filter frame that includes the ring-like filter frame main body 3 that is fitted to the front side of the lens barrel 2 (see FIG. 1) of the digital camera to control light, and is produced by molding a thermoplastic resin or a composite resin (e.g., fiber-reinforced plastic) having moderate elasticity, the filter lens 4 that is fitted (from the front side 16) to the lens-retaining inward protrusion section 19 and the lens fitting section 20 formed on the inner surface of the ring-like filter frame main body 3 so that the circumferential edge of the filter lens 4 comes in contact with the lens-retaining inward protrusion section 19, and the lens-retaining ring 28 that is fitted to the front side 16 of the filter lens 4, and can be pressure-welded to the edge of the lens fitting section 20 by ultrasonic welding, wherein the filter lens 4 is secured on the ring-like filter frame main body 3 via the lens-retaining inward protrusion section 19 and the lens-retaining ring 28 (see FIG. 8B).

FIGS. 9A and 9B illustrate an application example of the fifth embodiment of the invention. Since the lens-retaining ring 28 is pressure-welded to the lens-retaining inward protrusion section 19 by ultrasonic welding, excellent water-tightness is achieved between the lens-retaining ring 28 and the filter lens 4, and between the filter lens 4 and the lens-retaining inward protrusion section 19. However, it has been desired to improve water-tightness between the filter lens 4 and the filter frame main body 3 so that the digital camera can be used for waterside shooting, shooting in the rain, or shooting in the snow. The application example of the fifth embodiment of the invention provides a filter frame that can deal with such a demand.

The application example of the fifth embodiment of the invention provides a digital camera filter frame wherein a contact section 34 for the lens-retaining inward protrusion section that forms a circumferential edge section, and a contact section 35 for the lens-retaining ring are formed on the lens-retaining inward protrusion section 19 (see FIG. 9A) of the filter frame main body 3, and the contact section of the lens-retaining ring 28 (see FIG. 9B) with the filter lens 4, respectively, an irregular streak-like protrusion 36 that is formed along the circumferential direction is provided to the contact section 34 for the lens-retaining inward protrusion section and the contact section 35 for the lens-retaining ring, and the irregular streak-like protrusions 36 hold the filter lens 4 (not illustrated in FIGS. 9A and 9B) when the lens-retaining ring 28 is pressure-welded to the lens-retaining inward protrusion section 19 by ultrasonic welding to improve water-tightness between the lens-retaining ring 28 and the filter lens 4, and between the filter lens 4 and the lens-retaining inward protrusion section 19.

The invention thus provides a ring-like filter frame main body that is produced by molding a thermoplastic resin or a composite resin (e.g., fiber-reinforced plastic) having moderate elasticity, a filter lens having a specific effect being fitted to the ring-like filter frame main body. The invention also provides a digital camera filter frame that is formed in the shape of a ring-like filter frame main body by molding a thermoplastic resin or a composite resin (e.g., fiber-reinforced plastic) having moderate elasticity, wherein the lens-retaining inward protrusion section and the lens fitting section are formed on the inner surface of the ring-like filter frame main body, the filter lens is fitted to the lens-retaining inward protrusion section from the back side so that the circumferential edge of the filter lens comes in contact with the lens-retaining inward protrusion section, and the lens-retaining ring is fitted to the back side of the filter lens, and can be pressure-welded to the edge area of the lens fitting section by ultrasonic welding, wherein the filter lens is secured on the ring-like filter frame main body via the lens-retaining inward protrusion section and the lens-retaining ring. The ring-like filter frame main body and the digital camera filter frame can reduce the weight of a filter that is fitted to the front side of the lens barrel of a digital camera as compared with a known filter frame produced using a metal material (e.g., aluminum), and can significantly reduce the load imposed on an autofocus motor provided in the main body of the digital camera.

Since the ring-like filter frame according to the invention is produced by molding a thermoplastic resin or a composite resin that utilizes a synthetic resin (e.g., fiber-reinforced plastic), and the filter frame main body is produced using a thermoplastic resin or the like having relatively high elasticity, an impact suffered by the ring-like filter frame fitted to the front side of the lens barrel of the digital camera when the filter frame collides with something hard can be buffered by the elasticity of the filter frame (i.e., is not transmitted to the lens barrel), and a situation in which the optical axis of the lens barrel varies can be prevented.

The invention also provides a digital camera filter frame wherein a contact section that forms a circumferential edge section is respectively formed on the lens-retaining inward protrusion section formed on the filter frame main body and the contact section of the lens-retaining ring with the filter lens, the irregular streak-like protrusion that is formed along the circumferential direction is provided to each contact section, and the irregular streak-like protrusions hold the filter lens when the lens-retaining ring is pressure-welded to the lens-retaining inward protrusion section by ultrasonic welding to improve water-tightness between the lens-retaining ring and the filter lens, and between the filter lens and the lens-retaining inward protrusion section.

Since the filter frame according to the invention is produced by molding a thermoplastic resin or a composite resin that utilizes a synthetic resin (e.g., fiber-reinforced plastic) having moderate elasticity, the filter frame can be mass-produced, and the production cost can be significantly reduced.

### REFERENCE SIGNS LIST

1 Main body of digital single-lens reflex camera
2 Lens barrel
3 Filter frame main body
4 Filter lens
5 Female thread
6 Lens-retaining inward protrusion section
7 Lens fitting section
8 Circumferential edge
9 Male thread
10 Female thread part
11 Filter outer frame
12 Filter lens-retaining inward protrusion section
13 Filter lens
14 Filter-retaining ring
15 Optical axis of filter lens
16 Front side
17 Back side
18 Female thread
19 Lens-retaining inward protrusion section
20 Lens fitting section
21 Lens-retaining ring
22 Male thread
23 Circumferential edge
24 Burr groove
25 Welding ring fitting groove
26 Welding ring
27 Welding allowance
28 Lens-retaining ring
29 Welding ring fitting groove
30 Burr groove provided in outer circumference of welding ring fitting groove
31 Welding ring
32 Welding allowance
33 Welding stopper
34 Contact section of lens-retaining inward protrusion section
35 Contact section of lens-retaining ring
36 Streak-like protrusion

1. A digital camera filter frame that is formed of a polymer elastic body, and fitted to a front side of a lens barrel of a digital camera to control light, the digital camera filter frame being produced as a ring-like filter frame main body by molding the polymer elastic body, and a filter lens having a specific effect being fitted to the ring-like filter frame main body.

2. The digital camera filter frame according to claim 1, the digital camera filter frame being produced by producing the ring-like filter frame main body by molding the polymer elastic body, forming a lens-retaining inward protrusion section and a lens fitting section for the filter lens on an inner surface of the ring-like filter frame main body, fitting the filter lens to the lens-retaining inward protrusion section and the lens fitting section, and plastically deforming an end of a peripheral edge section of the lens fitting section by thermal caulking to secure the filter lens on the ring-like filter frame main body.

3. The digital camera filter frame according to claim 1, wherein the ring-like filter frame main body is produced by molding a thermosetting resin, a thermoplastic resin, or a composite material that utilizes a synthetic resin (e.g., fiber-reinforced plastic) as the polymer elastic body, a polymer elastic body that exhibits relatively high elasticity being selected as the polymer elastic body.

4. The digital camera filter frame according to claim 1, wherein parts that form the ring-like filter frame main body are respectively produced by molding a material that is arbitrarily selected from a thermosetting resin, a thermoplastic resin, and a composite material that utilizes a synthetic resin (e.g., fiber-reinforced plastic), and secured and coupled by thermal caulking, ultrasonic welding, and bonding using an adhesive to produce the filter frame.

5. The digital camera filter frame according to claim 1, wherein the ring-like filter frame main body is produced by molding a thermoplastic resin or a composite material that utilizes a synthetic resin (e.g., fiber-reinforced plastic) as the polymer elastic body, a polymer elastic body that exhibits moderate elasticity being selected as the polymer elastic body.

6. The digital camera filter frame according to claim 1, the digital camera filter frame comprising a lens-retaining inward protrusion section and a lens fitting section for the filter lens that are formed on an inner surface of the ring-like filter frame main body, the filter lens that is fitted from a back side to the lens-retaining inward protrusion section so that a circumferential edge of the filter lens comes in contact with the lens-retaining inward protrusion section, and a lens-retaining ring that is fitted to a back side of the filter lens, and can be pressure-welded to an edge of the lens fitting section by ultrasonic welding, wherein the filter lens is secured on the ring-like filter frame main body via the lens-retaining inward protrusion section and the lens-retaining ring.

7. The digital camera filter frame according to claim 1, the digital camera filter frame comprising a lens-retaining inward protrusion section and a lens fitting section for the filter lens that are formed on an inner surface of the ring-like filter frame main body, the filter lens that is fitted from a front side to the lens-retaining inward protrusion section so that a circumferential edge of the filter lens comes in contact with the lens-retaining inward protrusion section, and a lens-retaining ring that is fitted to a front side of the filter lens, and can be pressure-welded to an edge of the lens fitting section by ultrasonic welding, wherein the filter lens is secured on the ring-like filter frame main body via the lens-retaining inward protrusion section and the lens-retaining ring.

8. The digital camera filter frame according to claim 1, wherein the lens-retaining ring that can be welded to the edge of the lens fitting section by ultrasonic welding includes a lens-retaining ring that has a contact section that comes in contact with a circumferential edge of the filter lens, and a welding ring section that protrudes from the lens-retaining ring, and an end of the welding ring section forms a welding allowance.

9. The digital camera filter frame according to claim 1, wherein a contact section that forms a circumferential edge section is respectively formed on a lens-retaining inward protrusion section of the filer frame main body and a contact section of a lens-retaining ring with the filter lens, an irregular streak-like protrusion that is formed along a circumferential direction is provided to each contact section, and the irregular streak-like protrusions hold the filter lens when the lens-retaining ring is pressure-welded to the lens-retaining inward protrusion section by ultrasonic welding to improve water-tightness between the lens-retaining ring and the filter lens, and between the filter lens and the lens-retaining inward protrusion section.
